(19) United States
(12) Patent Application Publication
(10) Pub. No.: US 2008/0082678 A1
(43) Pub. Date: Apr. 3, 2008

(54) Communications Network System and Methods for Using Same

(75) Inventors: Yoav Lorch, Ramat-HaSharon (IL); Ehud Spiegel, Petach-Tikva (IL); Yossef Ilkanaev, Pardes-Chana-Karkur (IL)

Correspondence Address: Martin D. Moynihan;PRTSI, P.O. Box 16446, Arlington, VA, 22215, US

(73) Assignee: Zlango Ltd., Tel-Aviv (IL)

(21) Appl. No.: 11/795,319

(22) PCT Filed: Jan. 16, 2006
(86) PCT No.: PCT/IL06/00062

§ 371 Date: Jul. 16, 2007

Related U.S. Application Data
(60) Provisional application No. 60/644,021, filed on Jan. 18, 2005.

(30) Foreign Application Priority Data
Jan. 16, 2005 (IL) 166322

(51) Int. Cl. G06F 15/16

(52) U.S. Cl. 709/230

(57) ABSTRACT

A communications network system, comprising: a first user device, wherein the first user device uses a first communications protocol; a second user device, wherein the second user device uses a second communications protocol, different from the first communications protocol; and, a server, in operative communication with the first user device and the second user device, and wherein the server comprises a processor for translating the first communications protocol into the second communications protocol.

### RELATED APPLICATIONS

This application claims the benefit under 119(e) of U.S. Provisional Application No. 60/644,021, filed Jan. 18, 2005, invented by Yoav Lorch and also claims priority from Israel Application No. IL 166322, filed Jan. 16, 2005, entitled “Method and System for Iconic Language Communication”, the disclosures of which are herein incorporated by reference. The present application is also related to the application entitled “Iconic Communication” filed concurrently herewith in the Israel Receiving Office of the PCT, attorney docket number 524/04983, and to the application entitled “Communications Network System and Methods for Using Same” filed concurrently herewith in the Israel Patent Office, attorney docket number 524/05077, the disclosures of which are incorporated herein by reference.

### FIELD OF THE INVENTION

The present invention relates to the field of communication, and more specifically to a communications network system and methods for using same.

### BACKGROUND OF THE INVENTION

In the past few years, advancing technology has given people the ability to communicate as never before. For example, the advent of cellular communications networks, the Internet and other communications media make for quick and convenient means of conveying information from one person to another.

However, there are multiple competing technologies offering enhanced communication abilities, and often times each technology has multiple competing formats and/or protocols for carrying out that technology. As a result, interoperability of these systems, devices, formats, protocols and/or networks is a serious concern.

In addition, some of these technologies utilize devices with limited input capabilities, which in turn reduce the efficiency of communicating through these devices. Electronic messaging is one area where the reduced efficiency may be burdensome to a user. Some types of electronic messaging, such as SMS, operate in nearly real-time. A typical message will include multiple text characters. However, these messages are often sent using devices with limited input capability, such as cellular telephones which usually only have 12 keys. Entering multiple keystrokes to generate each text character may lead to a delay in responding to a message. This in turn may cause recipients to wait longer when receiving an instant message due to a user inputting characters on a limited input device. In a nearly real-time communication environment, such delay may be unacceptable. Furthermore, none of these new communications technologies are particularly helpful for communication across language barriers.

U.S. published patent application 2002/0140732, the disclosure of which is herein incorporated by reference, describes a method, system and storage medium for an iconic language communication tool. The system includes a host system for generating an iconic language communication template for receiving a user icon selection, presenting the iconic language communication template and receiving the user icon selection from the iconic language communication template. A network and a database are in communication with the host system.

U.S. published patent application 2002/0184309, the disclosure of which is herein incorporated by reference, describes systems and methods for reducing the amount of input a user is required to enter for an electronic message. When users change their capability to engage in an electronic messaging session, for instance when they go off-line, a command may be sent to other users. This command may take the form of a character sequence not normally occurring in the written language, which is interpreted by network devices and changes the display of the icon associated with the user who has gone off-line.

### SUMMARY OF THE INVENTION

An aspect of some exemplary embodiments of the invention relates to providing a communications network system which is capable of interoperable use with a plurality of protocols such as services, types of devices, formats and/or communications networks. In some exemplary embodiments of the invention, a sender of data in a first protocol has the data received by a receiver in a second protocol. In an exemplary embodiment of the invention, the data sent in the first protocol is translated into a second protocol by the communications network system by using a first header and at least a portion of the contents of the data. Optionally, the first header and at least a portion of the data are used to construct a second header for the data which is compatible with the second protocol. In some exemplary embodiments of the invention, the communications network system is used for transmitting an iconic language. In some exemplary embodiments of the invention, the communications network system is used for transmitting data and/or messages which are capable of activating software applications on a recipient's user device. Optionally, transmission of messages is conducted using at least some SMS messages.

An aspect of some exemplary embodiments of the invention relates to providing a communications network system which provides at least one group of iconic language icons to at least one user group associated with that group of iconic language icons. In some exemplary embodiments of the invention, a single icon is associated with more than one group of iconic language icons thereby allowing it to be simultaneously provided to more than one user group. In some exemplary embodiments of the invention, a group of iconic language icons is associated with more than one group of users thereby allowing the group of iconic language icons to be simultaneously provided to more than one group of users. Optionally, a group of users is associated with more than one group of iconic language icons thereby providing the group of users with more than just one group of iconic language icons. In some exemplary embodiments of the invention, the data is provided to at least one group of users from a server. Optionally, the data is provided to at least one group of users from a user. Optionally, the user providing the data is a member of the at least one group of user.

An aspect of some exemplary embodiments of the invention relates to providing a communications network system which conducts statistical analysis of messages at least partially in an iconic language and transmitted within the system. In some exemplary embodiments of the invention, messages are analyzed to gauge frequency and/or context of icon use. Optionally, analysis is conducted on messages to determine how much and/or in what relation certain icons are used with other icons. In some exemplary embodiments of the invention, statistical analysis is performed on an ongoing basis rather than a periodic basis. Optionally, analysis is conducted on user message-related preferences such as font size used, font used, colors used, and/or graphics used. In some exemplary embodiments of the invention, statistical analysis is used to determine which individual icons, groups of icons and/or other preferences are presented to users by default and/or are selectable for use by users. Optionally, statistical analysis is used for predicting yet-to-be-entered message content based on what message content has already been entered.

An aspect of some exemplary embodiments of the invention relates to providing a communications network system which optimizes message size based on the contents of the message. Optionally, the message is comprised of application data. Optionally, the message is transmitted via SMS. In some exemplary embodiments of the invention, content items are reduced to their minimum necessary size in order to optimize overall message size. Optionally, the communications network system analyzes message contents and automatically optimizes the message size prior to transmission to a receiver.

An aspect of some exemplary embodiments of the invention relates to a method for a communications network system to determine if a software application client installed on a user device is active. In an exemplary embodiment of the invention, an active software application client is generally considered to be one that is open on a user device and an inactive software application client is generally considered to be one that is closed on a user device. Optionally, a software application client is considered to be open if the user device is actively polling a server. Optionally, a software application client is considered to be open if the user device polled a server within a predefined period of time. Optionally, a software application client is considered to be closed if the user device hasn't polled the server for at least a predefined period of time. In some exemplary embodiments of the invention, the software application client sends a signal to a server that the client is opening or closing.

There is thus provided in accordance with an exemplary embodiment of the invention, a communications network system, comprising: a first user device, wherein said first user device uses a first communications protocol for transmission of data with a first header attached; a second user device, wherein said second user device uses a second communications protocol for transmission of data, different from said first communications protocol; and, a server, in operative communication with said first user device and said second user device, and wherein the server comprises a processor that uses the first header and at least some of the data content compatible with the first communications protocol to create a second header compatible with the second communications protocol. In some exemplary embodiments of the invention, the system further comprises a plurality of communications protocols from which said first communications protocol and said second communications protocol are selected. Optionally, the first communications protocol is selected from a group comprised of HTTP, TCP/IP, SMS, MMS, IMS, WAP, GSM, CDMA, iDEN, WCDMA, 3G or 4G. Optionally, the second communications protocol is selected from a group comprised of HTTP, TCP/IP, SMS, MMS, IMS, WAP, GSM, CDMA, iDEN, WCDMA, 3G or 4G.

There is thus provided in accordance with an exemplary embodiment of the invention, a communications network system, comprising: a first user device, wherein the first user device uses a first communications protocol for transmission of data, the data capable of activating a software application installed on a user device; a second user device, wherein the second user device uses a second communications protocol for receipt of the data; and, a server, in operative communication with the first user device and the second user device, and wherein the server comprises a processor that translates the first communications protocol into the second communications protocol by changing at least a data header according to a first communications protocol into a data header according to a second communications protocol. Optionally, the data is encompassed in an SMS message. In some exemplary embodiments of the invention, the system further comprises a plurality of communications protocols from which the first communications protocol and the second communications protocol are selected. Optionally, the server translates any one of the plurality of communications protocols into any of the other plurality of communications protocols.

There is thus provided in accordance with an exemplary embodiment of the invention, a method of translating data, comprising: sending data from a first user device to a second user device, wherein the first user device uses a first communication protocol different from a second communication protocol of the second user device; determining the second communication protocol of the second user device; and, translating the data from the first communication protocol to the determined second communication protocol of the second user device by exchanging a header in the first communication protocol and at least some content of the data with a header in the second communication protocol. Optionally, the first communication protocol is selected from a group comprising HTTP, TCP/IP, SMS, MMS, IMS, WAP, GSM, CDMA, iDEN, WCDMA, 3G or 4G. Optionally, the second communication protocol is selected from a group comprising HTTP, TCP/IP, SMS, MMS, IMS, WAP, GSM, CDMA, iDEN, WCDMA, 3G or 4G.

There is thus provided in accordance with an exemplary embodiment of the invention, a method of providing at least one icon of an iconic language to users of a communications network system, comprising: identifying users of the communications network system; creating a group of users comprised of at least one user, but less than all users, of the communications network system; assigning at least one icon to the group; and, providing the at least one icon to the group of users.

There is thus provided in accordance with an exemplary embodiment of the invention, a method of compiling statistics in an iconic language communication network system, comprising: transmitting at least one iconic language message; storing the at least one iconic language message on a database; analyzing the at least one iconic language message; and, compiling statistics based on the analyzing. Optionally, the analyzing comprises determining the context of at least one icon within the iconic language message. Optionally, the analyzing comprises determining the frequency of usage of at least one icon within the iconic language message.

There is thus provided in accordance with an exemplary embodiment of the invention, a method of optimizing a message size in a communications network system, comprising: composing a message comprised of at least one message element; placing the at least one message element in an acceptable format in use by the communications network system; analyzing the at least one message element for the applicability of at least one more efficient format in use by the communications network system; and, substituting the at least one more efficient format for the acceptable format where possible. Optionally, the acceptable format in use by the communications network system is icon-16 or text-16. Optionally, the at least one more efficient format is less than 16 bits but greater than 1 bit per character or icon.

There is thus provided in accordance with an exemplary embodiment of the invention, a method for determining the operational status of a software application client installed on a user device, comprising: analyzing a log file to determine the most recent polling time of the user device; estimating the time differential between the most recent polling time and the current time; and, classifying the operational status of the software application based on the estimating. Optionally, the time differential is greater than a predefined amount the operational status is classified as closed. Optionally, the time differential is less than a predefined amount the operational status is classified as open.

### BRIEF DESCRIPTION OF THE DRAWINGS

Exemplary non-limiting embodiments of the invention are described in the following description, read with reference to the figures attached hereto. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a block diagram depicting components of a communications network system, in accordance with an exemplary embodiment of the invention;

FIG. 2 is a block diagram depicting a server apparatus in a communications network system, in accordance with an exemplary embodiment of the invention;

FIG. 3 is a flowchart depicting a translation process, in accordance with an exemplary embodiment of the invention;

FIG. 4 is a flowchart depicting a data transmission method for MIDP 2 and some BREW protocols, in accordance with an exemplary embodiment of the invention;

FIG. 5 is a flowchart depicting a data transmission method for MIDP 1 and some BREW protocols, in accordance with an exemplary embodiment of the invention;

FIG. 6 is a flowchart depicting a message size optimization method, in accordance with an exemplary embodiment of the invention;

FIG. 7 is a flowchart depicting method of encoding a message, in accordance with an exemplary embodiment of the invention; and,

FIG. 8 is a flowchart depicting a method of using a communications network system, in accordance with an exemplary embodiment of the invention.

### DETAILED DESCRIPTION OF EXEMPLARY EMBODIMENTS

Exemplary Communications Network System

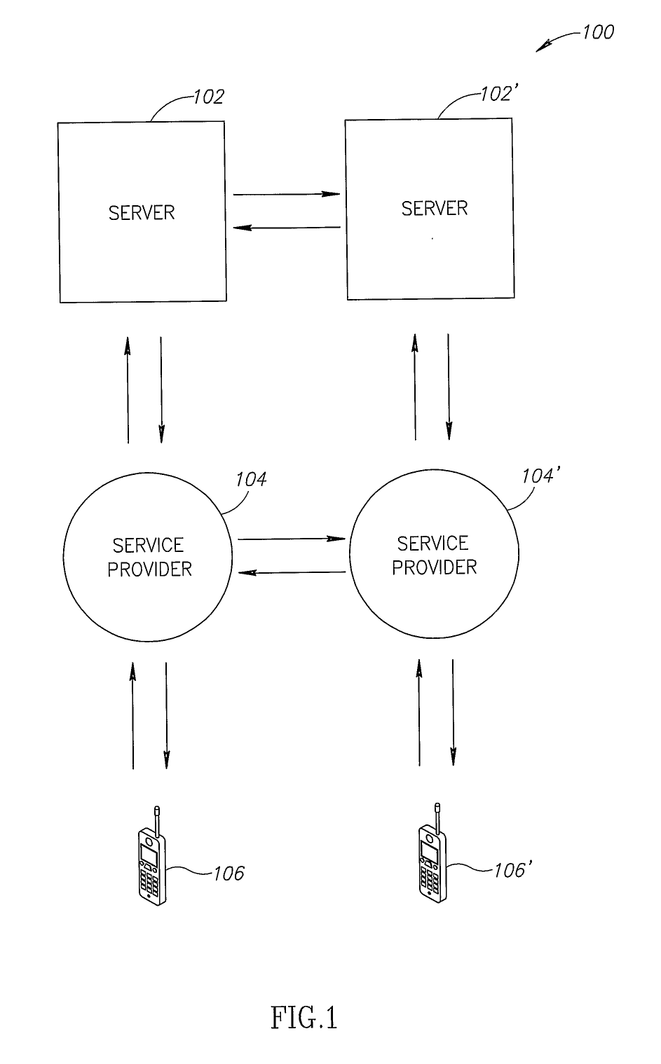

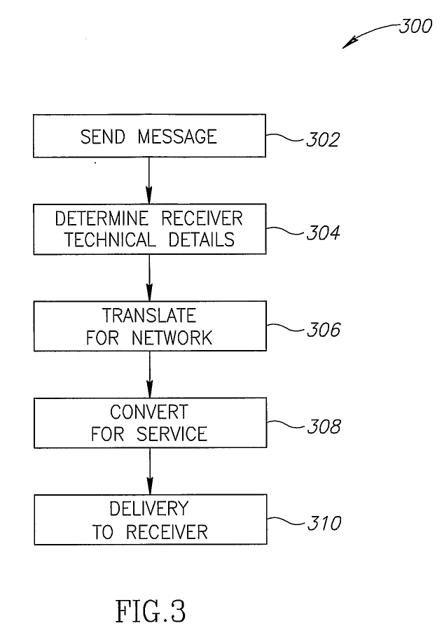

In an exemplary embodiment of the invention, a communications network system 100 (shown in FIG. 1) is provided which can optionally be integrated with existing communications networks. Optionally, communications network system 100 is a stand-alone system. In some exemplary embodiments of the invention, communications network system 100 is capable of performing a variety of tasks which enable more efficient, more convenient and/or more useful use of the communications networks. For example, in some exemplary embodiments of the invention, communications network system 100 translates (shown in FIG. 3) information from a sending, first user device in a first protocol and/or format into a second protocol and/or format in order for the information to be rendered usable by a receiving, second user device. In some exemplary embodiments of the invention, protocols include HTTP, TCP/IP, SMS, MMS, IMS, WAP, GSM, CDMA, iDEN, WCDMA, 3G and/or 4G. Optionally, more protocols are included, as described herein.

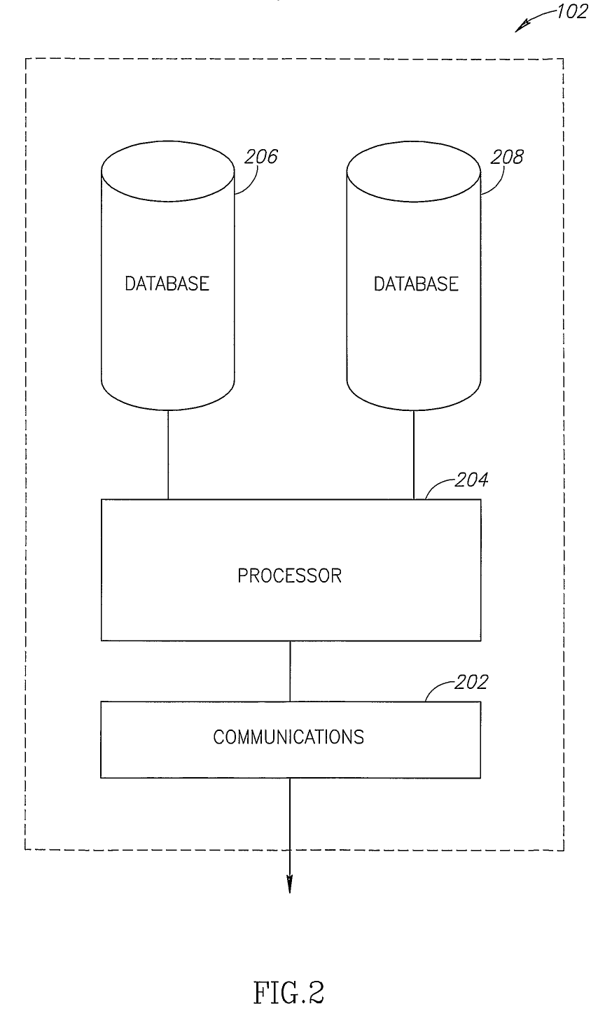

Referring to FIG. 1, a block diagram depicting components of communications network system 100 is shown, in accordance with an exemplary embodiment of the invention. In some exemplary embodiments of the invention, communications network system 100 is provided with at least one server 102. Server 102 is described in more detail with respect to FIG. 2, however, it should be understood that in some exemplary embodiments of the invention server 102 performs at least some tasks associated with making communications networks more efficient, more convenient and/or more useful. Server 102 is in operative communication to a service provider 104, in accordance with some exemplary embodiments of the invention. Service provider 104 is optionally any entity that provides communications and/or data transmission services to a user device 106. User device 106 is optionally any device, such as a cellular telephone, personal data assistant and/or computer, which is capable of receipt and/or transmission of data over a communications network. For example, Orange® (France and Israel, GSM protocol) or Verizon® (US, CDMA protocol), the cellular telephone companies, are considered service providers. Comcast® (US), a provider of cable and internet services, is also considered a service provider. In some exemplary embodiments of the invention, an individual server is associated with a particular service provider. Optionally, an individual server is associated with multiple service providers. In addition, servers are optionally not classified by service providers 104, for example servers are classified by geography in some exemplary embodiments of the invention. Optionally, a plurality of servers is associated with a single service provider 104.

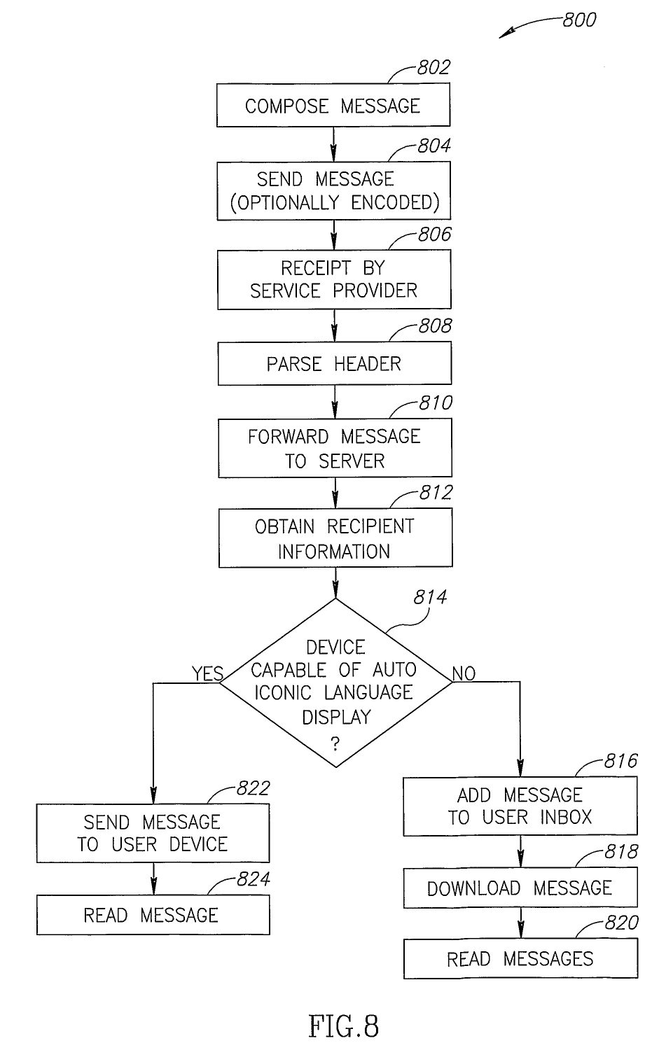

Briefly, an exemplary use of communications network system 100 is described. A more detailed description is provided below, with respect to FIG. 8. In an exemplary embodiment of the invention, user device 106 is operative to send data to a second user device 106′. In some exemplary embodiments of the invention, this is accomplished by user device 106 transmitting the data to service provider 104 associated with user device 106. At this stage, service provider 104 optionally sends the transmitted data to server 102 for server 102 to perform operations on the data to ensure its usability at second user device 106′. For example, if a second service provider 104′, with which second user device 106′ is associated, uses a different communications protocol than first service provider 104, server 102 translates the data into a protocol compatible with second service provider 104′. Optionally, data transmitted from service provider 104 initially goes to a second service provider 104′ and to a second server 102′ associated with second service provider 104′ in order to perform operations on the data to make it useable by second user device 106′. In an exemplary embodiment of the invention, second service provider 104′ forwards useable data to second user device 106′ for delivery. In some exemplary embodiments of the invention, second service provider 104′ stores the useable data for subsequent retrieval by the recipient.

It should be noted that in some exemplary embodiments of the invention, first user device 106 and second user device 106′ use the same service provider and/or are otherwise operationally compatible and thus, translation may not be necessary. In some exemplary embodiments of the invention, even though first user device 106 and second user device 106′ use the same service provider a translation is needed, for example, if first user device 106 uses MIDP 2 and second user device 106′ uses MIDP 1 (MIDP is explained below). However, server 102 may still perform operations, optionally on the data, including second user device technical capability detection, uploading and/or upgrading, user devices, data optimization, statistical analysis, billing, message archiving, data encoding, and the like. In some exemplary embodiments of the invention, servers 102, 102′ are operatively connected in order to allow communication between them directly.

In some exemplary embodiments of the invention, server functions are distributed amongst a plurality of servers. It should be noted that server 102, or a cluster of servers represented by server 102, may be central to serve all users in all locations, or may be placed in various geographical locations using a distributed architecture. In some exemplary embodiments of the invention using a distributed server, each geographical location server handles users communicating with other users in the same region. In some exemplary embodiments of the invention, communication with users outside of the geographical location is conducted by one geographical location server contacting another geographical location server. In an exemplary embodiment of the invention, users are assigned to different servers by using an identifier, for example the prefix of their telephone number.

In an exemplary embodiment of the invention, communications network system 100 is used for transmitting data which is capable of transmission via SMS. Optionally, the data relates to an iconic language. Optionally, the data relates to gaming and/or entertainment. Optionally, the data relates to imaging and/or graphics. Optionally, the data is textual in nature. Optionally, the data is audio and/or music related.

In an exemplary embodiment of the invention, communication over communications network system 100 originates from any of its component elements. For example, communication optionally originates from a user, a service provider and/or a server.

Exemplary Server

Referring to FIG. 2, a block diagram is shown depicting exemplary functional architecture of server 102, in accordance with an exemplary embodiment of the invention. In some exemplary embodiments of the invention, server 102 is a computer provided with at least one data processor 204 and/or at least one database 206 for data storage. Server 102 is also generally provided with communications 202 functionality in order to enable communication with other elements of communications network system 100. Optionally, server 102 communicates with other servers, service providers, databases, management systems and/or user devices.

As described above, server 102 is generally provided with at least one database 206 for data storage. Optionally, additional databases 208 are provided to server 102 for storage of additional data. In some exemplary embodiments of the invention, data comprises icons of an iconic language. In some exemplary embodiments of the invention, data comprises user information. In some exemplary embodiments of the invention, data comprises messages sent and/or received in communications network system 100. In some exemplary embodiments of the invention, data is any information related to the operation of communications network system 100 and/or related devices, such as server and/or client software.

In some exemplary embodiments of the invention, server 102 contains a database for centralized storage and maintenance of data related to an iconic language. Data related to an iconic language optionally includes language categories, language icons, icon identification, graphical images, icon names, and the like. This database optionally contains different versions and customizations of the iconic language. Optionally, the database is hierarchical and/or relational. In some exemplary embodiments of the invention, the iconic language database contains language category symbols directly or indirectly associated with the language icons. Optionally, the iconic language database contains language sub-category symbols subordinated to the language category symbols and associated with the language icons. Alternatively, the iconic language database does not associate icons to categories. In some exemplary embodiments of the invention, each language icon has a unique identification number assigned to it. Optionally, this identification is stored in database 206. Data processor 204 is capable of processing and managing the data stored in the databases and related to the language icons (e.g. icon names, ID, user group, help files, different language versions for each, etc.).

In accordance with some exemplary embodiments of the invention, the iconic language database is updated periodically. Optionally, updates to the iconic language database are full or partial updates. Optionally, a partial update includes adding or removing categories of icons. Optionally, a partial update includes adding or removing at least one icon, but not the whole category or subcategory to which the icon is assigned. In an exemplary embodiment of the invention, updates are initiated in response to a request from user device 106. Additionally or alternatively, updates are initiated in response to data transmitted from server 102 or service provider 104.

In an exemplary embodiment of the invention, the iconic language database contains at least one special language category (hereinafter “system category”) and at least one graphical image associated with this category (hereinafter “system icon”). The system icons contained in the system category are, for example, language icons, trademarks, logos, or other commercial graphical images. In some exemplary embodiments of the invention, these system icons are not available for a user while composing a message via a device, but are included in messages originated by server 102 and/or a third party server, such as second server 102′. Optionally, these system icons are received and read by a user.

The iconic language database, or a different database, optionally contains other non-iconic language icons such as those that are intended to indicate various control functions. For example, a send icon could be considered a control function apart from its everyday linguistic usage, with the send icon being used to send data, and not actually convey the word “send”. Another example of a control function icon could be a help icon, which is not necessarily intended to convey the word “help”, but rather to call up a help text and/or application to instruct the user about something.

The above databases optionally contain multiple variations of the iconic language icons, system icons, control function icons and/or other icons. Exemplary variations include: icons in different sizes to be used for different display sizes; and/or textual elements in different fonts/sizes/colors to match different display sizes; and/or to match users' preferences; and/or icons relevant to different languages. Furthermore, in some exemplary embodiments of the invention, the language category symbols, language sub-category symbols and/or language icons have associated names explaining the icon (or symbol) to the user. The icon names are optionally stored separately from the icons, and as such, may be in different languages from device to device.

In some exemplary embodiments of the invention, the icon language database and server 102 are used to provide language icons to a user device. Optionally, providing language icons depends on the technical abilities of the user device, such as memory and/or storage space. However, if a user device has memory for storing more icons than are included in a typical package, additional icons are optionally uploaded to, or downloaded by, the user from server 102. In some exemplary embodiments of the invention, data is hot swapped between server 102 and the user device depending on the needs of the user device. In an exemplary embodiment of the invention, an automated mechanism is used in which an icon or a whole category of icons are fetched from the server. Such methods are optionally used to build virtual/dynamic databases on user devices, and additionally, user devices with very limited storage memory are used more effectively. These methods are optionally generalized to support a full range from ample storage memory on the user device to no storage memory at all and working over communications network system 100.

In some exemplary embodiments of the invention, a user information database is provided to server 102. Information optionally includes: user device information; personal data; subscription information (described below); group membership (described below); billing information, service provider; user's contact list; token, and other useful information about the user. In an exemplary embodiment of the invention, the user information database also contains data related to user groups, the groups being comprised of a plurality of individual users (members). Optionally, a user can be a member of more than one group simultaneously. In some exemplary embodiments of the invention, data related to user groups includes: group names; user membership in the groups; rules for joining the group; icons and/or icon categories associated with each group; and the like.

Server 102 optionally contains an interface that allows users to create a new group and/or control the group's member list. For example, users are optionally permitted to send invitations to others to join a group, approve and/or deny requests to join, remove members, have administrator privileges over the group, grant such privileges to others, and the like. A user group could be comprised of stock brokers, people who live in New York City or sports fans, as examples.

In certain embodiments of the invention the names of iconic language icons may be tailored for specific user groups and/or self-customized by the group. The user group optionally also has a dedicated set of iconic language icons available to the group members only, for example by subscription to the dedicated set of iconic language icons. These dedicated language icons may be contained in generally available language categories as well as in special categories dedicated to the user group by subscription only. Different user groups optionally have different sets of dedicated icons and therefore, are optionally subscribed to different sets of dedicated icons. In some exemplary embodiments of the invention, a user group optionally personalizes the look and/or meaning of iconic language icons, add and/or delete iconic language icons, categories and sub-categories in accordance with the group's internal needs and preferences. In some exemplary embodiments of the invention, only members of a particular group are authorized to download the dedicated language icons. When using special icons for a user group, server 102 optionally manages the assignment of them to the member users of the user group by using the user phone number and/or other identification means. In an exemplary embodiment of the invention, a user group has at least one member and optionally, does not have all users of communications network system 100.

It should be noted that in an exemplary embodiment of the invention, the size of transmitted data can be reduced by indexing user group names to a table, the table correlating more efficient names (in terms of transmitted data size) to each group. For example, the user information database indicates that a user belongs to groups “abcdef” and “abcdeg”, and group “abcdef” is indexed as 1 while group “abcdeg” is indexed as 2 in the correlation table. In an exemplary embodiment of the invention, icons assigned to group “abcdef” are prefixed with the integer 1, instead of having to repeat the full name of the group before each icon assigned to it. In some exemplary embodiments of the invention, the correlation table also exists on user device 106. This saves significant message space in some exemplary embodiments of the invention. In an exemplary embodiment of the invention, server 102 supports different types of processes inside the group, for example interactive “democratic” or centralized decisions concerning new members, new icons, icon names, tailored graphical images of “common-use” icons, etc.

In an exemplary embodiment of the invention, server 102 is provided with a message database for storing some or all of the messages sent via server 102. Optionally, it analyzes the messages for various purposes, including gauging the frequency and/or context of icon use. Optionally, analysis is conducted on messages to determine how much and/or in what relation certain icons are used with other icons.

Exemplary Translation Process

Referring to FIG. 3, an exemplary process 300 for translation is depicted in accordance with an exemplary embodiment of the invention. Translation is optionally required if a user sends (302) data according to a first communications protocol, such as from one network and/or service format to a receiver who uses a different, second communications protocol. According to some embodiments of the invention, server 102 translates data to be compatible between cellular telephone networks, broadband networks, POTS networks, the Internet network, other data communication networks, and/or between different services (e.g. messaging services like SMS, MMS, instant messaging, IMS and others, mobile advertising, mobile-content service, etc.) based on a determination (304) of the receiver's technical details (e.g. network, service format, etc.). In an exemplary embodiment of the invention, server 102 optionally translates (306) between different types of networks, such as between a CDMA cellular telephone networks and GSM cellular telephone networks. In an exemplary embodiment of the invention, translation is facilitated by implementing the Java 2 Platform, Micro Edition (“J2ME”) Wireless Toolkit supporting the Java Technology for the Wireless Industry specification (e.g. http://java.sun.com/products/j2mewtoolkit/) at a user device, such as first user device 106 and second user device 106′. The J2ME Wireless Toolkit is a toolbox for developing wireless applications designed to run on cell phones, mainstream personal digital assistants, and other small mobile devices. The toolkit includes emulation environments, performance optimization and tuning features. In an exemplary embodiment of the invention, data in the form of a message body is the same, but a message header is different between the various networks. For example, a J2ME port number for a GSM J2ME network is optionally different than a Class ID in a CDMA BREW-based network.

The J2ME toolkit may also include a Wireless Messaging API (WMA) that provides platform-independent access to wireless communication resources like Short Message Service (SMS). In some exemplary embodiments of the invention, server 102 facilitates converting a received message into a message complying with a specific service transmission protocol. For example, for complying with the SMS service, server 102 converts (308) a message into the SMS payload. In an exemplary embodiment of the invention, the message transmission for SMS communication optionally has different implementations for client-client and client-server modes of operation.

In client-client mode the message contains a standard SMS header (e.g. as used in GSM, CDMA, etc.) including a destination phone number, and server 102 designated port number of a user device (typically different from the default or other “well known” port numbers; in CDMA BREW it may be called as “Class ID”), and data, which can be characterized as a message and/or as the SMS data payload. In some embodiments of the invention, the port number/Class ID are in the contents of the general SMS payload. For example, a GSM non-J2ME user device might show the port number as part of the SMS data content. Optionally, the message is in an iconic language. Optionally, the message is encoded, for example as described below.

In client-server mode, the message contains a standard SMS header (e.g. as used in GSM, CDMA, etc.) with a server address as an intermediate destination, while the SMS payload (data content) contains another message header (including final destination URI) attached by data transmission software to the message. Upon arrival at the intermediate destination, the server takes the final destination URI out of the SMS payload and puts it as the SMS destination, while optionally putting in the sender URI, extracted from the SMS arriving at the server, as part of the SMS payload, so the recipient client will be able to identify the sender.

Final Destination URI may be in various formats:

a. To another phone: tel://[phone number], e.g. tel://+972544550135;

b. To an email: email://[email address], e.g. email://abc@aol.com;

c. Direct to an IP: udp://[ip address]:[port], e.g. udp://127.0.0.1:8009;

d. To Instant Messaging user, etc.

In an exemplary embodiment of the invention, server 102, acting as an intermediate destination, recognizes the standard SMS headers, handles the rest of the message as payload and forwards it to the final destination device for delivery (310). Optionally, the header is analyzed by server 102 to determine where to deliver the message. Upon receiving the SMS-formatted message, the receiving user device extracts the SMS header and forwards the rest of the message to a message reading application for display to the receiving user. Optionally, the SMS-formatted message is decoded, encoding/decoding described below, prior to being displayed on the receiving device. Optionally, the displayed message is in an iconic language. In some exemplary embodiments of the invention, the server generates messages in a manner similar to the messages originated by a user device. This capability is optionally used for sending system-originated messages of different types, for example, for advertising, personalized content services, update alerts, etc.

Exemplary Methods for Transmitting Data to a User Device

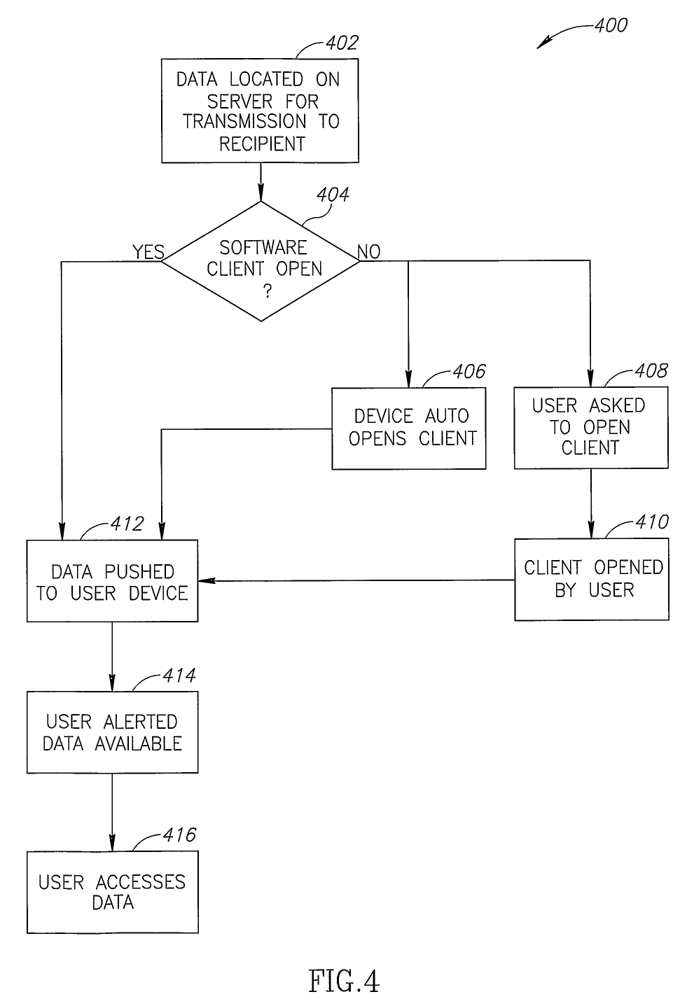

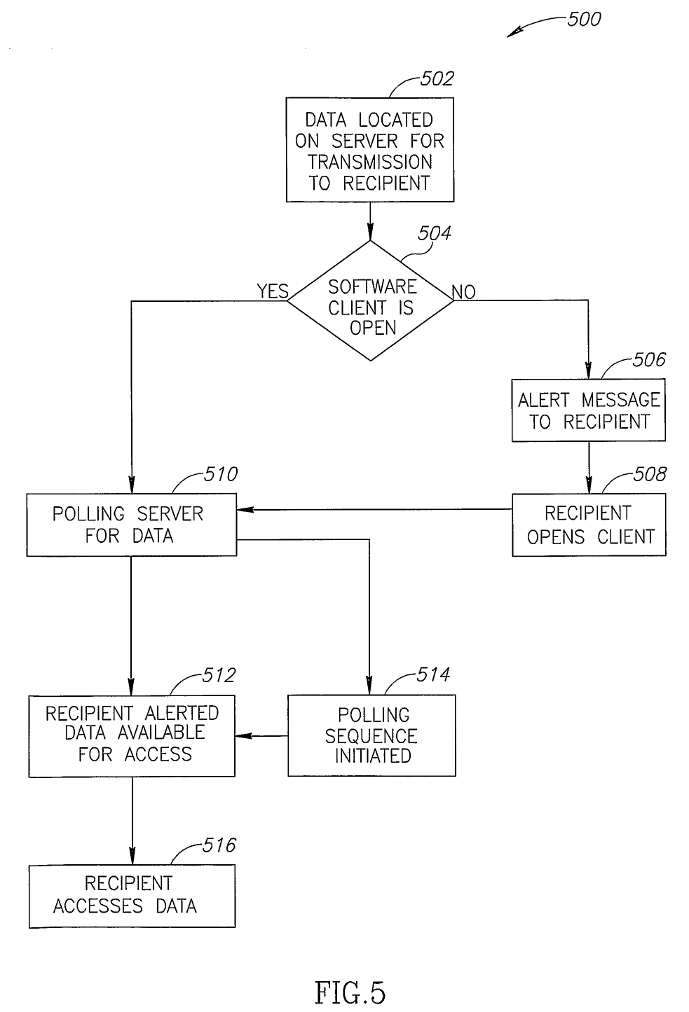

In some exemplary embodiments of the invention, communications network system 100 uploads data, such as software and/or icons, to a device in order to make the device more useful and/or operable with communications network system 100. In some exemplary embodiments of the invention, communications network system 100 is capable of transmitting data to user devices 106, 106′ in a “push” and/or “pull” mode of communication. Optionally, “push” and/or “pull” modes are selected based on a device's particular technological abilities. Optionally, what data is transmitted to a user device is selected based on the device's particular technological abilities and/or installed software status and/or business considerations when more than one option is supported; for example a service provider might prefer to use the MIDP 1 “pull” method for all user devices instead of the MIDP 2 “push” method, since the service provider prefers a billing model for WAP/HTTP over an SMS billing model (WAP/HTTP vs. SMS described in more detail below with respect to FIGS. 4 and 5). In an exemplary embodiment of the invention, software is pre-loaded on a user device prior to commencement of use by the user. In some exemplary embodiments of the invention, software is downloaded by and/or uploaded to the user device. Optionally, software is downloaded by and/or uploaded to the user device using over-the-air (“OTA”) technologies.

GSM Mobile Information Device Profile (“MIDP”) is the J2ME implementation for handheld user devices (a detailed description can be found at http://wwwjcp.org). Some of the currently available user devices support MIDP 1 version (specification JSR-37) while a newer generation of user devices supports MIDP 2 version (specifications JSR-118 and up). The principal difference between the versions, as far as some embodiments of the present invention are concerned, is that MIDP 2 allows a software application to register as a default handler of data, such as for SMS messages that are received on a specific port, whereas MIDP 1 does not allow that. Thus, on MIDP 2 devices it is possible to send messages in “push” mode, and have the device OS transfer them automatically to the proper software application for handling, whereas on MIDP 1 devices it is required that the proper software application work in “pull” mode in order to ensure that it handles the messages and not the default messaging software on the device. In an exemplary embodiment of the invention, transfer of a message to the proper software application for handling also includes automatically activating the software application so that it may perform operations on the message at the user device. It should be noted that future generations of MIDPs, JSRs or similar applications are likely to have this ability to associate a particular software application as the default handler of particular types of data and that the described methods and apparatuses herein apply to these newer devices and applications (e.g. MMS, IMS).

In an exemplary embodiment of the invention, various scenarios exist in a client-server operation mode for data transmission to a user device, depending on the user device level of support (i.e. MIDP 1, MIDP 2 and WMA for the GSM J2ME, and BREW for CDMA). In an exemplary embodiment of the invention, WMA enables the sender user device to issue an SMS from a software application. In an exemplary embodiment of the invention, MIDP 2 enables a recipient user to open the message automatically using the appropriate software application. For example, if the sender transmits a message to the receiver which is in an iconic language, upon receipt, a receiver with MIDP 2 will automatically have the iconic language message opened by a software application designed to display the message. In an exemplary embodiment of the invention, most BREW user devices are capable of automatically opening an iconic language message with the appropriate software, however not all BREW user devices can and MIDP 1 user devices cannot. The various scenarios are discussed in more detail below.

In an exemplary embodiment of the invention using MIDP 2 or BREW capable of client activation by SMS, activation of software and sending and/or receipt of data are accomplished using SMS messages. Referring to FIG. 4, a flowchart 400 depicting a method of transmitting data to a MIDP 2/BREW (capable of SMS client activation) device is shown, according to an exemplary embodiment of the invention. In an exemplary embodiment of the invention, data is located (402) on server 102 and is made available for transmission to the recipient's device. Server 102 determines (404) the operational status of the client, that is if the recipient device's software client is likely open or closed. In some exemplary embodiments of the invention, the software application client sends a signal to a server that the client is opening or closing. Optionally, this signal is stored in a database and indexed to the user device which has sent the signal. If it is determined (404) that the software client is likely closed, either the recipient device automatically (406) opens the client or the recipient is asked (408) by the recipient device to open the software application client for displaying the SMS, in accordance with an exemplary embodiment of the invention. Once the software client is automatically (406) opened or the recipient opens (410) the client, or if the software client was open to begin with, the data located (402) on server 102 is pushed (412) to the recipient's device. In an exemplary embodiment of the invention, the software client alerts (414) the recipient that the data is ready to be accessed (416).

In an exemplary embodiment of the invention using MIDP 1 or BREW (not capable of automatic software client activation), activation of a software client is conducted using HTTP and/or TCP/IP and/or WAP formats. Referring to FIG. 5, a flowchart 500 is shown depicting a method for transmitting data to a recipient using MIDP 1 or BREW (not capable of automatic software client activation), in accordance with an exemplary embodiment of the invention. Optionally, the server also generates a unique token during activation to identify the user device during communication with server 102 and communications network system 100. In some exemplary embodiments of the invention, this token is used in all subsequent correspondence with communications network system 100 to identify the user device. Optionally, the token is a randomly generated alphanumeric number. Once data is located (502) on server 102 for transmission to a recipient, sending data in a MIDP 1 or BREW, which cannot activate client software by SMS, environment is optionally conducted using HTTP and/or TCP/IP and/or WAP formats. Receipt of messages in this operational environment uses a combination of SMS alerts and HTTP/WAP and/or TCP/IP polling requests, in accordance with an exemplary embodiment of the invention. In an exemplary embodiment of the invention, it is determined (504) if the software client is open at the recipient's device. Optionally, a software application client is considered to be open if the user device is actively polling a server, polling being described below. Optionally, a software application client is considered to be open if the user device polled a server within a predefined period of time. Optionally, a software application client is considered to be closed if the user device hasn't polled the server for at least a predefined period of time. Optionally, the predefined period of time is up to 5 minutes. Optionally, the predefined period of time is greater than 5 minutes. Optionally, the predefined period of time is set to a different time, depending on various considerations, such as server loading and/or customer service. If the client is closed at the receiver's device and/or there is no other information on the client's status, the server generates (506) an alerting SMS, and the user opens (508) the client on the receiver's device manually. In an exemplary embodiment of the invention, once the client is opened, whether following the alerting SMS or by user-initiative, the client performs the following actions in accordance with an exemplary embodiment of the invention:
Polling (510) and retrieving the SMS messages (by a ‘Get’ command) that are stored and waiting at server 102 or 102′. This also informs server 102 or 102′ that the client is on. The server optionally verifies the client identity by using the unique identification token.
Subsequent to the initial retrieval of messages, an optional progressive polling sequence is initiated (514) with the pollings gradually increasing in time interval from each other until the polling sequence stops. For example, a first polling is 30 seconds after retrieving the messages stored on the server, a second polling is 30 seconds after the 1^{st} polling, a third polling is 1 minute later (i.e. 2 minutes from start), a 4^{th} polling is 2 minutes later (i.e. 4 minutes from start) and a 5^{th} polling occurs 4 minutes after the 4^{th} polling (8 minutes from start). These time intervals and number of pollings are by way of example only. In an exemplary embodiment of the invention, a log is created on a database indicating at least the time of each polling. In an exemplary embodiment of the invention, this log is used to determine the operational status of the software application client, whether it is open or closed. For example, any indication in the log of no communication with the client since the last polling, or greater than a predefined period of time, is optionally considered as the client being closed.

In an exemplary embodiment of the invention, the recipient is alerted (512) that data is available for accessing (516) after polling (510), (514). In an exemplary embodiment of the invention, polling for waiting SMS messages occurs in response to a user sending a message. Optionally, the polling sequence described above commences in response to a user sending a message or, in some exemplary embodiments of the invention, if the client is “awakened” after a period of inactivity.

In some exemplary embodiments of the invention, server 102 and/or 102′ records the time of any polling made by the client. Server 102 and/or 102′ optionally checks the time that has elapsed from the last polling every time the server receives an SMS message for the user. If the elapsed time is greater than a predefined interval then the server optionally generates an alert SMS to send to the user. In some exemplary embodiments of the invention, the server analyzes the messages waiting for the user and generates an alert for messages which have not been retrieved by the user and have been waiting for longer than a predetermined period of time. Optionally, the server makes a notation that an alert was generated for the waiting SMS message. It should be noted that in some exemplary embodiments of the invention, the server stores messages and assigns a unique identification number to each one. Optionally, a retrieved message is deleted from the user's inbox and/or the server. Optionally, stored messages are analyzed for statistics gathering. In order to save database queries, in some exemplary embodiments of the invention, the server uses a dedicated queue for the SMS messages that are waiting for the next scan and have not generated an alert SMS yet.

Message Format and Optimization

In an exemplary embodiment of the invention, the format of various types of messages is described below. Note that the first content field of all ZMS messages is an exception to the TLV rule (described below), it is the Protocol Version and its length is six bits, in an exemplary embodiment of the invention. Optionally, if its value is 0, it is considered to be an escape character, meaning that the next 12 bits will be taken as the Protocol Version, if the protocol ever needs to go beyond 63 versions. In an exemplary embodiment of the invention, the Protocol Version is encoded as a single character in URL-safe Base 64 (or in case of the use of escape, a zero followed by two URL-safe Base 64 characters).

Following is a description of various message types with the name of each field type in < > brackets. Each field type has a different value of “T” in the TLV scheme, described below.

In an exemplary embodiment of the invention, an activation message is constructed using the following format: Protocol Version<Activation Identifier><Security Token><Device Type><Phone Number><Operator> <Software Client Version Number><Language><Nickname>, where:
1. <Activation Identifier> is a type which has no value—it merely indicates that the message is an activation message so its length is always O— the length field will contain 0.
2. <Security Token> is the token described above to be used for identifying and verifying the identity of a user device.
3. <Device Type> optionally contains a string which identifies the type of user device being used. In an exemplary embodiment of the invention, it is part of the installation file and as such it is supplied as part of the client during the download.
4. <Phone Number> is the receiver's phone number. In an exemplary embodiment of the invention, the format has to be a full international number.
5. <Software Client Version Number> is optionally a Unicode string provided as part of the client during the download process.
6. <Language> is optionally a Unicode string, settable by the user.
7. <Nickname> is optionally a Unicode string, selected by the user and/or communications network system.

In an exemplary embodiment of the invention, the activation message is optionally re-transmitted for updating the server in case of various events, such as changing the user name, installing special icon packages, transferring the SIM-card to a different user device, etc. The activation message is also optionally used to enable instant service in cases that an external download server is used where there may be a significant delay in generating reports on new users. In an exemplary embodiment of the invention, a response to this message is a new Security Token, which is included with subsequent messages (as described herein). The first time this registration message is sent, the Security Token is optionally a blank field (0 length).

In an exemplary embodiment of the invention, an outgoing message is as follows: Protocol Version<Security Token> <Destination-Phone-Number><Sender Phone Number><Sender Nickname><SMS Content>. Although the <Sender Nickname> is optionally extracted by the server, it is inserted for optional verification purposes. In some exemplary embodiments of the invention, <Sender Phone Number> is included in the message when it is sent to server 102 via HTTP. In an exemplary embodiment of the invention, when the message is sent by SMS, the recipient should be able to see the sender's phone number. In some embodiments of the invention, the sender's phone number is used to match it with the security token. Alternatively, the sender's phone number is not sent and server 102 infers it from the security token. In an exemplary embodiment of the invention, an incoming message is as follows: Protocol Version<Sender Phone Number><Sender Nickname><SMS Content>.

In an exemplary embodiment of the invention, an alternative outgoing message format is used which condenses the <Security Token> <Destination-Phone-Number><Sender Phone Number><Sender Nickname> into a single <Header> TLV. Optionally, there are at least three varieties of <Header>, including: <Simple Header> which excludes the Sender Phone Number and the Nickname; <Header With Nickname> which excludes only the Sender Phone Number; and <Header With Nickname and Sender Phone> which includes all the fields.

In an exemplary embodiment of the invention, iconic language SMS messages are encoded using a TLV format—Type, Length, and Value. This optionally allows new information to be added to iconic language SMS messages by adding new types. The type field is optionally 8 bits long, allowing for 255 types plus an “escape” type if 255 proves to be too few. The length field optionally allows an older client to skip over the value field of a new, unknown type, in accordance with some exemplary embodiments of the invention. The length field is optionally 10 bits long, allowing for a length of up to 1K for a single chunk. The length field will optionally specify a size in bits to allow for a given type to define its own implicit chunking size, allowing for best use of available space. For example, icons could be encoded using an Icon-9 type, which would mean that 9 bits would be used for each icon id, allowing for icon values up to 512, or Icon-12 which would use 12 bits per icon id and allow for icon values up to 4095.

In an exemplary embodiment of the invention, iconic language SMS content is a sequence of TLV's taken from three categories: <Icon-#>, <Text-#>, and <Extended-Icon-#>, where # is one of the available values for the particular type, as listed below (for example, Icon-7, Text-16).

A Text TLV <Text-#> contains a sequence of Unicode characters, in accordance with some exemplary embodiments of the invention. The particular # chosen will determine how many bits are used for each Unicode character id. For example, Text-16 allocates 16 bits per Unicode character, thereby covering the whole range. Optionally, Text-7 or Text-12 are used with the invention to allow messages which use a more limited part of the full Unicode spectrum (for example, English uses the lower 7 bits of Unicode). Optionally, 2 to 16 bits are used per character. Optionally, more than 16 bits are used per character.

An Icon TLV <Icon-#> contains a sequence of icon identifications, in some exemplary embodiments of the invention. The particular # will determine how many bits are used for each icon identification. In some exemplary embodiments of the invention, Icon-9 is used which allocates 9 bits (512 possibilities) for each icon identification. Optionally, Icon-16 or more is used, to allow for a larger range of icon identifications. Optionally, 2 to 16 bits are used per icon.

In order to support multiple icon sets, there is an Icon Set ID in accordance with some exemplary embodiments of the invention. In an exemplary embodiment of the invention, this is a sixteen bit integer value, allowing a very wide range of add-on icon sets. In any given icon set, the identification of the icons will start from 1. In order to include these icons in a regular SMS, the Icon Set ID is optionally specified in combination with the icon ID. In an exemplary embodiment of the invention, a user has only a few add-on icon sets and therefore an Icon Set Table TLV and an Extended Icon TLV are used.

The Icon Set Table TLV <Icon Set Table> contains a list of up to 16 Icon Set ID's, in some exemplary embodiments of the invention. These are the add-on Icon Set ID's which are used in a message. If there are none, no Icon Set Table TLV need appear in the message. If there are fewer than 16, the TLV can be correspondingly shorter.

In an exemplary embodiment of the invention, an Extended Icon TLV <Extended-Icon-#> is like an Icon TLV, but it contains an additional 4-bit field at the beginning which is an index into the Icon Set Table, specifying which Icon Set ID is applicable to the sequence of Icon ID's contained in the TLV.

A practical result of this scheme is that a message which contains, for example, 10 icons from 10 different add-on icons sets, will have 10 Extended Icon TLV's. A message which contains, for example 10 icons from the default icon set followed by 10 icons from a single add-on set, will contain 2 TLV's—an Icon TLV with the first 10 icon ids, followed by an Extended Icon TLV with the index in the Icon Set Table of the add-on set id and then the 10 remaining icon ids.

In some exemplary embodiments of the invention, there is a mixed content TLV, which is used for optimal encoding of messages which contain both icons and text. The mixed content TLV optionally has a header which indicates the bit-width used for icon encoding and text encoding. Those numbers are fixed for the duration of that mixed content TLV, in some exemplary embodiments of the invention. Afterwards, there are alternating segments of icons ids and text, each optionally preceded by an eight bit length field.

Types which are optionally used are listed below. In an exemplary embodiment of the invention, the number in the list is the number used to represent the type in the encoding. The encoding scheme for the contents of a field is determined by the type, in accordance with an exemplary embodiment of the invention. Optionally, the contents of a field are encoded in Unicode 7—meaning that the contents are in chunks of 7 bits, each of which is to be interpreted as an unsigned integer representing a Unicode value. When we use the term Unicode-7, it refers to a data format only, with no specific semantics. Text-7 is a data type in the protocol which refers to textual content of an SMS message, encoded using the Unicode-7 data format.

Exemplary type fields which are used in accordance with some exemplary embodiments of the invention, include:
1. <Registration Identifier>
2. <Security Token>
3. <Device Type>
4. <Sender Phone Number>
5. <Operator>
6. <Client Version Number>—provided as part of installation
7. <Language>—provided as part of installation or language update
8. <Sender Nickname>—contents encoded in Unicode 16.
9. <Destination Phone Number>
10-19. <Icon-#># can be any number from 7 through 16, which correspond to 10-19. This encodes a series of icon identifications, where each icon identification is represented by # bits.
20-29. <Text-#># can be any number from 7 through 16, which corresponds to 20-29. This encodes a series of Unicode characters, where each character is represented by # bits.
30-39. <Extended-Icon-#> like <Icon-#>, but with an additional 4 bit field before the series of icon identifications. The 4 bit field represents an index into an Icon Set Table.
40. <Icon-Set-Table> is a series of 16 bit icon set identifications. There can be up to 16 such identifications. In an exemplary embodiment of the invention, one <Icon-Set-Table> TLV appears in a message. Optionally, multiple such TLV's appear, allowing for more than 16 add-on icon sets. In such a scenario, a reference to an Icon Set Table is optionally to the most recent prior Icon Set Table in the message.
41. <Content Check> contains a 16 bit value giving the length in bits of the message up to the point where the Content Check appears. In an exemplary embodiment of the invention, it is placed at the end of the message, to allow verifying that the complete contents of the message were received.
42. <Mixed Content> is a special format for encoding most messages which contain both text and icons. Its goal, in an exemplary embodiment of the invention, is to reduce to a minimum the overhead involved in switching back and forth between text and icons inside a message. Optionally, it starts with two 4 bit fields, the first of which gives the number of bits used per icon, and the second of which gives the number of bits used per character of text. After that, it has an optionally alternating sequence of an icon chunk and a text chunk, as many times as is necessary until the whole message is encoded. Each chunk optionally starts with an 8 bit field indicating the number of items (either icons or characters) in the chunk. (Thus this TLV cannot be used for messages which contain text strings longer than 255 characters.) In an exemplary embodiment of the invention, the data subsequently appears, with each item taking the number of bits indicated in the header of the TLV. It should be noted that if a messages starts with a text string, the Mixed Content TLV will still optionally start with an icon chunk. The length of that chunk will optionally be 0. Likewise, if a message has a series of icons longer than 255, say 265, the Mixed Content TLV will encode this as an icon chunk of length 255, a zero length text chunk, and another icon chunk of length 10, in accordance with some exemplary embodiments of the invention.
To summarize an exemplary internal structure of <Mixed Content>:
   <icon id width><text char-width>(<icon-chunk><text-chunk>)* where:
<icon-chunk>=<numIcons><icon-id-1><icon-id-2> . . . .
<text-chunk>=<strLength><char-1><char-2> . . . .
It is noted that in some exemplary embodiments of the invention numIcons and/or strLength are 0.
43. <Simple Header> contains 18 bits of security token, 2 bits for phone number prefix type, and 50 bits which includes the destination phone number, in accordance with an exemplary embodiment of the invention. It should be noted that the bit sizes are by way of example only, and any bit size is optionally used which enables proper transmission of the message to which the header is attached. In some exemplary embodiments of the invention, a separation is used between the prefix encoding and the number encoding. This is because in some embodiments of the invention, encoding the full destination phone number means that any non-numerical prefix cannot be encoded and/or because any information about leading zeroes will be lost. In an exemplary embodiment of the invention, the valid prefix types are: (0=NO_PREFIX, 1=PLUS_PREFIX, 2=SINGLE_ZERO_PREFIX, 3=DOUBLE_ZERO_PREFIX).
44. <Header with Nickname> is like <Simple Header> in some exemplary embodiments of the invention, but adds the Nickname encoded using Text-12. Note that in some embodiments of the invention, the length of the nickname can be derived from the length of the full TLV minus the first two fixed fields.
45. <Header with Nickname and Sender Phone> <Header with Nickname> in some exemplary embodiments of the invention, but optionally adds an additional 2 bit phone prefix and 50 bit phone number for the sender phone which follows the destination phone number and precedes the variable length nickname.

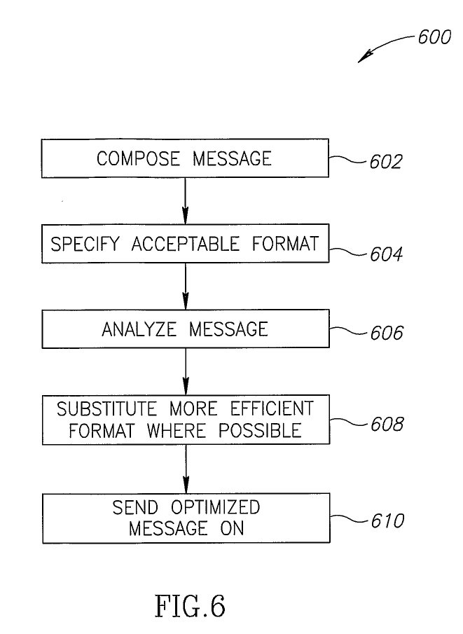

Communications network system 100 is also capable of optimizing data being transmitted in system 100, in accordance with some exemplary embodiments of the invention. Referring to FIG. 6, a flowchart 600 is shown of a method for optimizing message sizes, in accordance with an exemplary embodiment of the invention. After a message has been composed (602), but before it is transmitted (610) to service provider 104 or otherwise operated on by user device, there is an optional optimization stage. Any acceptable format useable by communications network system 100 is specified (604) by default for at least one element of the composed message, such as a text or iconic character. Optionally, the least efficient format in use by communications network system 100 is used. Optionally, this format is Icon-16 and/or Text-16 depending on whether the message uses icons, text or both.

Instead of putting logic in the application which chooses appropriate type-variants (Icon-9 or Icon-12, for example, or Text-7 vs. Text-16), the application optionally specifies the least efficient variant (Icon-16 or Text-16), and then has an optimizer which analyzes (606) the message contents and substitutes (608) a more efficient type where possible. In other words, if the application uses Text-16 for all text, the optimizer analyzes each character to see whether the contents use any of the higher order bits. If not, the client can simply change the chunk to use Text-7 or Text-12, depending on how many of the higher order bits are unused. The same applies to icons. In an exemplary embodiment of the invention, message size is optimized by selecting type variants which occupy less space.

Security

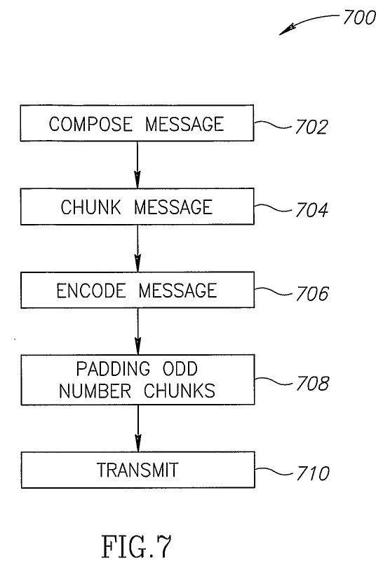

In addition to the use of a security token, as described above, user devices and server 102 are capable of encoding and/or decoding messages (including iconic and text segments, when relevant) to facilitate transmitting in a format compatible with the current standards of messaging services. The process 700 of encoding/decoding an iconic message is further illustrated in FIG. 7, in accordance with an exemplary embodiment of the invention. After a message is composed (702), it is subsequently further encoded (or “channel-encoded”) using URL-safe Base 64 encoding (using the A-Z, a-z, 0-9,*-, Characters), to ensure safe transmission over SMS and HTTP, in accordance with an exemplary embodiment of the invention. Encoding into URL-safe Base 64 includes chunking (704) the message into 6-bit chunks, without regard to the TLV structure. In an exemplary embodiment of the invention, Base 64 encoding (706) is conducted by taking 6 bits at a time of the content of the message and mapping this to a character in the URL-safe variant of Base 64. In an exemplary embodiment of the invention, messages whose length in bits is not a multiple of 6 are right-padded (708) with “0” bits to make their length a multiple of 6. Note that in some embodiments of the invention, the values of the 6 bit chunks are interpreted as beginning with the highest order bit. So “100000” is 32, and “000001” is 1. In some exemplary embodiments of the invention, at least one header is added to the content of the message, for example to identify the format of the message and/or the recipient and/or the sender. Upon encoding the message, it is transmitted (710) in accordance with an exemplary embodiment of the invention. Decoding of the message occurs sometime prior to the recipient reading it. Optionally, decoding occurs at the recipient's device. Optionally, decoding occurs at server 102 or 102′.

Exemplary Method of Use

When an iconic language software application client runs for the first time, the client optionally gets a nickname from the user and sends an activation/registration message to server 102 which includes the nickname and the device type. In some exemplary embodiments of the invention, the nickname is in English characters. The user device type information is optionally taken from the installed version (in the case of J2ME, from the JAD file). In an exemplary embodiment of the invention, this registration message is optionally resent to update the information, for example if the user wants to update their nickname and/or if the user wants to transfer their SIM to a new device.

Referring to FIG. 8, a flowchart 800 is shown depicting a method of use, in accordance with an exemplary embodiment of the invention. After a user composes (802) an iconic message on a user device, the user initiates a transmission of the message, in accordance with some exemplary embodiments of the invention. The user device optionally encodes the message prior to sending (804) it, as described above. In an exemplary embodiment of the invention, the message is received (806) by service provider 104. After receiving (806) the message, service provider 104 optionally parses (808) the message header, recognizes that the message is an iconic message per special mark (e.g. port number) and forwards (810) the message to server 102 associated with service provider 104, or to the recipient's service provider 104′ for further operations.

In some exemplary embodiments of the invention, server 102 or 102′ server identifies the recipient and obtains (812) recipient related information from the user database upon receipt of the message in order to determine how to deliver the message. For example, if a message is sent to someone's e-mail address, in accordance with an exemplary embodiment of the invention, server 102 decodes the received encoded iconic language message, creates an image file with the appropriate icons, and sends an email message to the target email address via SMTP, with the image file as an attachment to this message. In this way, standard e-mail clients are able to receive iconic messages without needing to conduct any installations, etc. Similarly, to support instant messaging, e.g. ICQ, the server optionally sends the message via the ICQ protocol, as if it were sent from another ICQ client.

In an exemplary embodiment of the invention, if the iconic language message is sent to a cellular telephone user device, server 102 attempts to determine (814) recipient device type and/or what method it is using for receiving messages. It might be, for example, CDMA BREW, MIDP or another method. In an exemplary embodiment of the invention, iconic language messages sent to a recipient who uses a device which cannot display the message (for example MIDP1 devices) may be added (816) to server 102, for example in the recipient's message inbox. In certain embodiments of the invention, server 102 informs the recipient about a new message by sending a notification message (e.g. ordinary SMS sent to the recipient's device) and/or other alerts. The recipient optionally activates an iconic language messaging application and downloads (818) the message by polling server 102 (“pull” mode) in order to read (820) the message. Older generations of user devices with J2ME implementations might be lacking a WMA module that provides the option of generating an SMS from the application. Is such cases, the client would optionally initiate an IP (typically HTTP or WAP) session with the server that subsequently communicates the message to the recipient. In an exemplary embodiment of the invention, if the recipient's device supports MIDP 2, server 102 optionally sends (822) the iconic language message to a designated port of the device. The iconic language messaging application is automatically activated in some exemplary embodiments of the invention and the recipient optionally receives a notification and/or reads (824) the iconic language message in a manner similar to a regular SMS message (“push” mode).

In an exemplary embodiment of the invention, if the recipient's device is not empowered to display iconic language messages and/or there is any other reason why the receiver is absent in the user information database, server 102 optionally notifies the sender via service provider 104 about a delivery failure. In certain exemplary embodiments of the invention, server 102 optionally translates, as described with reference to FIG. 3, the iconic language message into a format acceptable by the recipient and sends the translated message to the recipient via service provider 104. Alternatively, server 102 creates a WAP page with a rendered image of the message for transmission to the recipient. Optionally, the WAP page is matched to various common screen sizes. Optionally, using continuation links, the rendered message is divided into consecutive pages. In some exemplary embodiments of the invention, the recipient's device is optionally identified by its profile or ID carried by the WAP transaction protocol by the UA-Prof or/and UA-Header. In an exemplary embodiment of the invention, a suitable WAP page is rendered to match the device's display and/or browsing capabilities. The WAP page also optionally contains a link to download client software from a download server. Alternatively to the WAP page solution, server 102 optionally notifies users that do not have a suitable user device for displaying iconic language messages that the rendered message is available for viewing at a certain Web location allowing the recipient to view it using a suitable means such as a computer connected to the Internet. Optionally, the message is sent to the recipient in text. Optionally, the message is sent to an e-mail address of the recipient.

In some exemplary embodiments of the invention, software applications are downloaded to a user device and are still capable of being used without activating the software applications at server 102 and/or without receiving a security token (as described above). For example, a software application that is downloaded to user device 106 and installed may not necessarily have to interact with server 102 in order to function, in which case the application may operate as normal strictly on user device 106. Optionally, a software application is downloaded to user device 106 to be installed and tried on a trial basis. In a trial basis exemplary embodiment of the invention, activation may only occur after the trial period has elapsed.

In some exemplary embodiments of the invention, apparatuses and methods are used with communications network system 100 such as those described in the application entitled “Iconic Communication” filed concurrently herewith according to the PCT, attorney docket number 524/04983, and the application entitled “Communications Network System and Methods for Using Same” filed concurrently herewith in the Israel Patent Office, attorney docket number 524/05077, the disclosures of which are incorporated herein by reference.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A communications network system, comprising:
a first user device, wherein said first user device uses a first communications protocol for transmission of data with a first header attached;
a second user device, wherein said second user device uses a second communications protocol for transmission of data, different from said first communications protocol; and,
a server, in operative communication with said first user device and said second user device, and wherein the server comprises a processor that uses the first header and at least some of the data content compatible with the first communications protocol to create a second header compatible with the second communications protocol.

2. A communications network system according to claim 1, wherein said first communications protocol is selected from a group comprised of HTTP, TCP/IP, SMS, MMS, IMS, WAP, GSM, CDMA, iDEN, WCDMA, 3G or 4G.

3. A communications network system according to claim 1, wherein said second communications protocol is selected from a group comprised of HTTP, TCP/IP, SMS, MMS, IMS, WAP, GSM, CDMA, iDEN, WCDMA, 3G or 4G.

4. A communications network system, comprising:
a first user device, wherein said first user device uses a first communications protocol for transmission of data, the data capable of activating a software application installed on a user device;
a second user device, wherein said second user device uses a second communications protocol for receipt of the data; and,
a server, in operative communication with said first user device and said second user device, and wherein the server comprises a processor that translates the first communications protocol into the second communications protocol by changing at least a data header according to a first communications protocol into a data header according to a second communications protocol.

5. A communication network system according to claim 4, wherein data is encompassed in an SMS message.

6. A communications network system according to claim 1, further comprising a plurality of communications protocols from which said first communications protocol and said second communications protocol are selected.

7. A communications network system according to claim 6, wherein said server translates any one of the plurality of communications protocols into any of the other plurality of communications protocols.

8. A method of translating data, comprising:
sending data from a first user device to a second user device, wherein said first user device uses a first communication protocol different from a second communication protocol of said second user device;
determining said second communication protocol of said second user device; and,
translating said data from said first communication protocol to said determined second communication protocol of said second user device by exchanging a header in the first communication protocol and at least some content of the data with a header in the second communication protocol.

9. A method according to claim 8, wherein said first communication protocol is selected from a group comprising HTTP, TCP/IP, SMS, MMS, IMS, WAP, GSM, CDMA, iDEN, WCDMA, 3G or 4G.

10. A method according to claim 8, wherein said second communication protocol is selected from a group comprising HTTP, TCP/IP, SMS, MMS, IMS, WAP, GSM, CDMA, iDEN, WCDMA, 3G or 4G.

11. A method of providing at least one icon of an iconic language to users of a communications network system, comprising:
identifying users of said communications network system;
creating a group of users comprised of at least one user, but less than all users, of said communications network system;
assigning at least one icon to said group; and,
providing said at least one icon to said group of users.

12. A method of compiling statistics in an iconic language communication network system, comprising:
transmitting at least one iconic language message;
storing the at least one iconic language message on a database;
analyzing said at least one iconic language message; and,
compiling statistics based on said analyzing.

13. A method according to claim 12, wherein said analyzing comprises determining the context of at least one icon within said iconic language message.

14. A method according to claim 12, wherein analyzing comprises determining the frequency of usage of at least one icon within said iconic language message.

15. A method of optimizing a message size in a communications network system, comprising:
composing a message comprised of at least one message element;
placing the at least one message element in an acceptable format in use by said communications network system;
analyzing the at least one message element for the applicability of at least one more efficient format in use by said communications network system; and,
substituting said at least one more efficient format for said acceptable format where possible.

16. A method according to claim 15, wherein said acceptable format in use by said communications network system is icon-16 or text-16.

17. A method according to claim 15, wherein said at least one more efficient format is less than 16 bits but greater than 1 bit per character or icon.

18. A method for determining the operational status of a software application client installed on a user device, comprising:
analyzing a log file to determine the most recent polling time of said user device;
estimating the time differential between the most recent polling time and the current time; and,
classifying the operational status of the software application based on said estimating.

19. A method according to claim 18, wherein when said time differential is greater than a predefined amount the operational status is classified as closed.

20. A method according to claim 18, wherein when said time differential is less than a predefined amount the operational status is classified as open.
